(19) United States
(12) Patent Application Publication
(10) Pub. No.: US 2025/0309262 A1
(43) Pub. Date: Oct. 2, 2025

(54) POSITIVE ELECTRODE AND SOLID-STATE BATTERY

(71) Applicant: Murata Manufacturing Co., Ltd., Nagaokakyo-shi (JP)

(72) Inventor: Yusuke MORINO, Nagaokakyo-shi (JP)

(21) Appl. No.: 19/234,380

(22) Filed: Jun. 11, 2025

Related U.S. Application Data
(63) Continuation of application No. PCT/JP2023/043831, filed on Dec. 7, 2023.

(30) Foreign Application Priority Data
Jan. 16, 2023 (JP) 2023-004494

(51) Int. Cl. H01M 4/58; H01M 4/02; H01M 4/136; H01M 4/36; H01M 4/62

(52) U.S. Cl. CPC H01M 4/5825; H01M 4/136; H01M 4/366; H01M 4/624; H01M 2004/021; H01M 2004/028

(57) ABSTRACT

A positive electrode including: a positive electrode current collector; and a positive electrode active material layer on the positive electrode current collector. The positive electrode active material layer includes: a first positive electrode active material region on the positive electrode current collector, and includes first positive electrode active material particles and a solid-state electrolyte; and a second positive electrode active material region on a side of the first positive electrode active material region opposite to the positive electrode current collector, and includes second positive electrode active material particles and the solid-state electrolyte. A volume ratio between the first positive electrode active material particles and the solid-state electrolyte in the first positive electrode active material region is within a range from 6:4 to 8:2, both inclusive. A median diameter of the second positive electrode active material particles is greater than a median diameter of the first positive electrode active material particles.

### CROSS REFERENCE TO RELATED APPLICATIONS

The present application is a continuation of International application No. PCT/JP2023/043831, filed Dec. 7, 2023, which claims priority to Japanese Patent Application No. 2023-004494, filed Jan. 16, 2023, the entire contents of each of which are incorporated herein by reference.

### TECHNICAL FIELD

The disclosure relates to a positive electrode including a solid-state electrolyte, and to a solid-state battery including the positive electrode.

### BACKGROUND ART

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member.

Recently, a solid-state battery has been developed that is a secondary battery including a solid-state electrolyte instead of a liquid or gel electrolyte that includes a material such as an organic solvent (for example, see PTLs 1 and 2).
PTL 1: Japanese Unexamined Patent Application Publication No. 2017-157529
PTL 2: Japanese Unexamined Patent Application Publication No. 2014-238925

### SUMMARY OF THE DISCLOSURE

Consideration has been given in various ways to improve performance of a solid-state battery, as described in the patent literatures in the above citation list. There is, however, room for improvement in terms of the performance of the solid-state battery.

The technology has been made in view of such an issue and it is an object of the technology to provide a solid-state battery having superior performance, and a positive electrode to be included in the solid-state battery.

A positive electrode according to one embodiment of the disclosure includes a positive electrode current collector, and a positive electrode active material layer on the positive electrode current collector. The positive electrode active material layer includes: a first positive electrode active material region on the positive electrode current collector, and includes first positive electrode active material particles to each of which a solid-state electrolyte is adhered; and a second positive electrode active material region on a side of the first positive electrode active material region opposite to the positive electrode current collector, and includes second positive electrode active material particles to each of which the solid-state electrolyte is adhered. A volume ratio between the first positive electrode active material particles and the solid-state electrolyte in the first positive electrode active material region is within a range from 6:4 to 8:2, both inclusive. A median diameter of the second positive electrode active material particles is greater than a median diameter of the first positive electrode active material particles.

According to the solid-state battery including the positive electrode of one embodiment of the disclosure, the volume ratio between the first positive electrode active material particles and the solid-state electrolyte in the first positive electrode active material region that is relatively near to the positive electrode current collector as compared with the second positive electrode active material region is within a range from 6:4 to 8:2, both inclusive. In addition, the median diameter of the first positive electrode active material particles is smaller than the median diameter of the second positive electrode active material particles. This allows a larger amount of the solid-state electrolyte to be present around the first positive electrode active material particles. Accordingly, a favorable ion conduction path is formed, and it is possible to achieve superior performance such as an improved rate characteristic without an energy density being impaired.

Note that effects of the disclosure are not necessarily limited to those described above and may include any of a series of effects described below in relation to the disclosure.

### BRIEF DESCRIPTION OF DRAWINGS

FIG. 1 is a schematic sectional diagram illustrating a configuration example of a solid-state battery according to one embodiment of the disclosure.

FIG. 2 is a schematic sectional diagram illustrating a configuration example of a positive electrode applied to the solid-state battery illustrated in FIG. 1.

### DESCRIPTION OF THE PREFERRED EMBODIMENTS

Some embodiments of the disclosure are described below in detail with reference to the drawings. The description is given in the following order.
0. Outline of Technology
1. Embodiment
1.1 Configuration of Solid-State Battery
1.2 Method of Manufacturing Solid-State Battery
1.3 Action and Effects of Solid-State Battery
2. Examples

Note that a “solid-state battery” of the disclosure refers to a battery including a component that is in a solid state. For example, the “solid-state battery” of the disclosure is a stacked-type solid-state battery in which layers are stacked on each other. The layers each include, for example, a sintered body. The “solid-state battery” of the disclosure encompasses not only a secondary battery that is repeatedly chargeable and dischargeable but also a primary battery that is simply dischargeable.

### 0. Outline of Disclosure

First, an outline of the disclosure is described.

Consideration has been given in various ways in relation to improvement in performance of a solid-state battery. The solid-state battery includes a solid-state electrolyte, and therefore typically has superior high-temperature resistance and high safety, as compared with a battery including a liquid electrolyte.

PTL 1 proposes a positive electrode active material layer having a configuration in which a first active material layer and a second active material layer different from each other in void rate are stacked in order from a side of a current collector. Specifically, the void rate of the first active material layer is set to be greater than or equal to 0% and less than 10%, and the void rate of the second active material layer is set to be greater than or equal to 10% and less than 60%, to thereby cause the positive electrode active material layer to be easily impregnated with a precursor solution of a solid-state electrolyte upon manufacturing the positive electrode active material layer. However, because the void rate of the second active material layer is greater than or equal to 10% and less than 60%, an electrode including such a positive electrode active material layer may suffer a decrease in energy density, which may lead to a concern that a battery capacity may decrease. Further, an average particle size of a positive electrode active material in a form of particles included in the first active material layer is set to be greater than or equal to 100 nm and less than 5 μm. This may cause, when a film of an ion-conductive material is to be formed on a surface of the positive electrode active material in the form of particles, a volume occupancy of the positive electrode active material to be relatively reduced, which may lead to a decrease in the battery capacity.

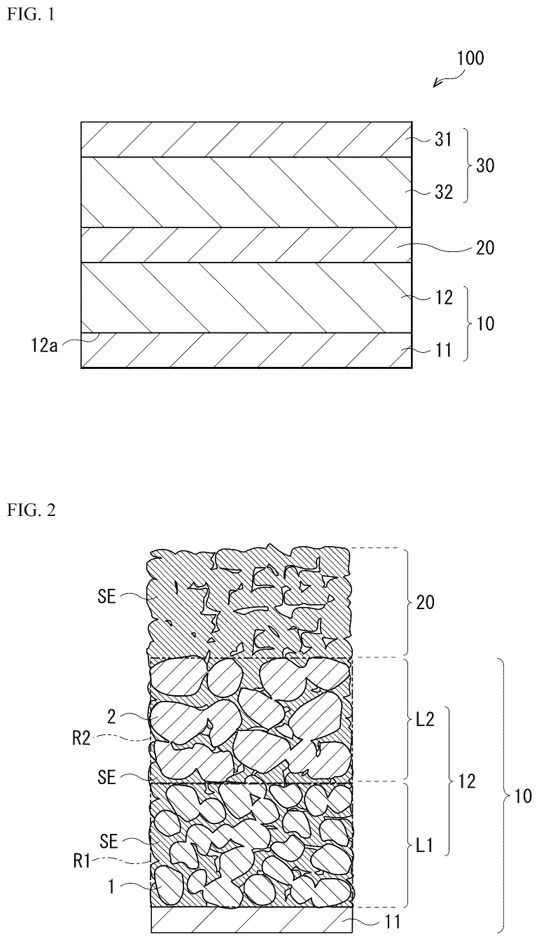

In PTL 2, as illustrated in FIG. 1 thereof for example, a volume ratio of a positive electrode active material to a solid-state electrolyte material in a second positive electrode active material layer 12b is set to be smaller than a volume ratio of the positive electrode active material to the solid-state electrolyte material in a first positive electrode active material layer 12a. The second positive electrode active material layer 12b is on a side of a solid-state electrolyte layer 40. The first positive electrode active material layer 12a is on a side of a positive electrode current collector 11. This is for making a Li-ion conduction path thick by increasing the solid-state electrolyte material on the side of the solid-state electrolyte layer, and thereby improving a rate characteristic. In the invention of PTL 2, however, the positive electrode active material in the second positive electrode active material layer 12b is set to a smaller amount, which seems to make it still difficult to avoid a decrease in battery capacity.

In view of the above-described circumstances, the Applicant proposes below a positive electrode that makes it possible to achieve higher ion conductivity while suppressing a decrease in battery capacity, and a solid-state battery including the same.

### 1. Embodiment

### [1.1 Configuration of Solid-State Battery]

Referring to FIGS. 1 and 2, a description is given of a configuration of a solid-state battery 100 as an embodiment of the present disclosure. FIG. 1 is an outline sectional diagram schematically illustrating a configuration of the solid-state battery 100. The solid-state battery 100 has a stacked structure in which a positive electrode 10, a solid-state electrolyte layer 20, and a negative electrode 30 are stacked in order. The negative electrode 30 includes a negative electrode current collector 31 and a negative electrode active material layer 32. The solid-state battery 100 may have a structure in which multiple units are stacked one by one on top of each other. The units each include the positive electrode 10, the solid-state electrolyte layer 20, the negative electrode 30, and the solid-state electrolyte layer 20 that are stacked in order.

### [Positive Electrode 10]

FIG. 2 is a schematic sectional diagram illustrating, in an enlarged manner, a part of the positive electrode 10 and a part of the solid-state electrolyte layer 20 included in the solid-state battery 100. The positive electrode 10 is an electrode layer including at least a positive electrode active material. The positive electrode 10 includes a positive electrode current collector 11 and a positive electrode active material layer 12.

The positive electrode current collector 11 includes, for example, a metal foil. The positive electrode current collector 11 may include, for example, at least one metal (a simple substance of metal element) selected from the group consisting of Al (aluminum), Cu (copper), Mg (magnesium), Ti (titanium), Fe (iron), Co (cobalt), Ni (nickel), Zn (zinc), Ge (germanium), In (indium), Au (gold), Pt (platinum), Ag (silver), and Pd (palladium), or an alloy including two or more metal elements selected from the above-described group, as a constituent material. The positive electrode current collector 11 may also be a sintered body. This is to allow the solid-state battery 100 to be formed by integral firing, or to reduce an internal resistance of the positive electrode current collector 11. When the positive electrode current collector 11 is the sintered body, the positive electrode current collector 11 may include a conductive additive and a sintering aid. The conductive additive that may be included in the positive electrode current collector 11 may be of the same kind as a conductive additive that may be included in, for example, the positive electrode active material layer 12. The sintering aid that may be included in the positive electrode current collector 11 may be of the same kind as a sintering aid that may be included in, for example, the positive electrode active material layer 12.

Examples of an adoptable shape of the positive electrode current collector 11 include a plate shape, a foil shape, and a mesh shape. A surface of the positive electrode current collector 11 may be smooth or uneven.

### [Positive Electrode Active Material Layer 12]

The positive electrode active material layer 12 includes the positive electrode active material as a major component. The positive electrode active material included in the positive electrode active material layer 12 contributes to insertion and extraction of an ion in the solid-state battery 100 and also contributes to supplying and receiving of an electron to and from an external circuit. The ion moves between the positive electrode 10 and the negative electrode 30 via the solid-state electrolyte. In other words, ion conduction occurs between the positive electrode 10 and the negative electrode 30 via the solid-state electrolyte. The insertion and extraction of the ion into and from the positive electrode active material respectively involve reduction and oxidation of the positive electrode active material. An electron or a hole for such oxidation and reduction reactions is supplied to the positive electrode 10 or the negative electrode 30, which allows charging and discharging to proceed. The positive electrode active material layer 12 is, for example, a layer which a lithium ion, a sodium ion, a proton (H⁺), a potassium ion (K⁺), a magnesium ion (Mg²⁺), an aluminum ion (Al³⁺), a silver ion (Ag⁺), a fluoride ion (F⁻), or a chloride ion (Cl⁻) is insertable into and extractable from. That is, the solid-state battery 100 is an all-solid-state secondary battery that is to be charged and discharged by the above-described ion moving between the positive electrode 10 and the negative electrode 30 via the solid-state electrolyte.

### [Positive Electrode Active Material]

The positive electrode active material included in the positive electrode 10 includes, for example, at least one selected from the group consisting of, for example, a lithium-containing phosphoric acid compound having a NASICON structure, a lithium-containing phosphoric acid compound having an olivine structure, a lithium-containing layered oxide, and a lithium-containing oxide having a spinel structure. Examples of the lithium-containing phosphoric acid compound having the NASICON structure include Li₃V₂(PO₄)₃. Examples of the lithium-containing phosphoric acid compound having the olivine structure include Li₃Fe₂(PO₄)₃, LiFePO₄, LiMnPO₄, and LiFe_{0.6}Mn_{0.4}PO₄. Examples of the lithium-containing layered oxide include LiCoO₂, LiCo_{1/3}Ni_{1/3}Mn_{1/3}O₂, and LiCo_{0.8}Ni_{0.15}Al_{0.05}O₂. Examples of the lithium-containing oxide having the spinel structure include LiMn₂O₄ and LiNi_{0.5}Mn_{1.5}O₄.

The positive electrode active material which a sodium ion is insertable into and extractable from includes, for example, at least one selected from the group consisting of, for example, a sodium-containing phosphoric acid compound having a NASICON structure, a sodium-containing phosphoric acid compound having an olivine structure, a sodium-containing layered oxide, and a sodium-containing oxide having a spinel structure.

As illustrated in FIG. 2, the positive electrode active material layer 12 has a stacked structure in which a first positive electrode active material region L1 and a second positive electrode active material region L2 are stacked in order on the positive electrode current collector 11.

The first positive electrode active material region L1 is provided on the positive electrode current collector 11, and is a porous molded body including first positive electrode active material particles 1 to each of which a solid-state electrolyte SE is adhered. The first positive electrode active material particles 1 include the positive electrode active material described above. The solid-state electrolyte SE is present around the first positive electrode active material particles 1. The solid-state electrolyte SE is also present in a gap between the first positive electrode active material particles 1. Note that the solid-state electrolyte SE in the first positive electrode active material region L1 has multiple voids. Details of the solid-state electrolyte SE will be described later. Further, a volume ratio between the first positive electrode active material particles 1 and the solid-state electrolyte SE in the first positive electrode active material region L1 may be within a range from 6:4 to 8:2 both inclusive.

The second positive electrode active material region L2 is provided on an opposite side of the first positive electrode active material region L1 to the positive electrode current collector 11. The second positive electrode active material region L2 is a porous molded body including second positive electrode active material particles 2 to each of which the solid-state electrolyte SE is adhered. The second positive electrode active material particles 2 include the positive electrode active material described above. The positive electrode active material included in the second positive electrode active material particles 2 may be the same as or different from the positive electrode active material included in the first positive electrode active material particles 1. The solid-state electrolyte SE is present around the second positive electrode active material particles 2. The solid-state electrolyte SE is also present in a gap between the second positive electrode active material particles 2. Note that the solid-state electrolyte SE in the second positive electrode active material region L2 also has multiple voids. Further, a volume ratio between the second positive electrode active material particles 2 and the solid-state electrolyte SE in the second positive electrode active material region L2 may be within a range from 6:4 to 8:2 both inclusive.

The positive electrode active material layer 12 of the present embodiment is not limited to an embodiment in which a border between the first positive electrode active material region L1 and the second positive electrode active material region L2 is clear in a section along a stacking direction, and may include an embodiment in which the border between the first positive electrode active material region L1 and the second positive electrode active material region L2 is unclear in the section along the stacking direction. Further, a thickness of the first positive electrode active material region L1 and a thickness of the second positive electrode active material region L2 may be substantially equal, or may be different from each other.

Note that it is possible to calculate the volume ratio between the first positive electrode active material particles 1 and the solid-state electrolyte SE in the first positive electrode active material region L1 by, for example, based on an image of any section of the first positive electrode active material region L1 along the stacking direction, determining each of: a sum total of respective sectional areas of the first positive electrode active material particles 1 present in a unit region (for example, a region R1 surrounded by a dash-dotted line in FIG. 2); and a sum total of sectional areas of the solid-state electrolyte SE present in the unit region (the region R1).

It is possible to calculate the volume ratio between the second positive electrode active material particles 2 and the solid-state electrolyte SE in the second positive electrode active material region L2 by, for example, based on an image of any section of the second positive electrode active material region L2 along the stacking direction, determining each of: a sum total of respective sectional areas of the second positive electrode active material particles 2 present in a unit region (for example, a region R2 surrounded by a dash-dotted line in FIG. 2); and a sum total of sectional areas of the solid-state electrolyte SE present in the unit region (the region R2).

A filling rate F of the positive electrode active material layer 12 may be set to be, for example, greater than or equal to 85%. As used herein, the filling rate F is a volume occupancy of the first positive electrode active material particles 1, the second positive electrode active material particles 2, and the solid-state electrolyte SE in the positive electrode active material layer 12, and is a volume proportion of a part other than the voids in the positive electrode active material layer 12. The filling rate F may be calculated by acquiring an image of any section of the positive electrode active material layer 12 with a scanning electron microscope (SEM), for example, and performing a calculation with image processing software. Specifically, for example, ImageJ developed in the public domain is used as the image processing software and an area of all of any sectional image (SEM image) of the positive electrode active material layer 12 is determined from the SEM image by “Set Measurement”. Thereafter, contrast portions corresponding to the voids are determined by “Threshold”. “An area of the contrast portions corresponding to the voids” is determined by “Limit to Threshold” in “Set Measurement”. The following is determined as the filling rate F: (area of all of SEM image—area of contrast portions corresponding to voids)/area of all of SEM image×100 (%).

In the positive electrode active material layer 12 of the present embodiment, a median diameter of the second positive electrode active material particles 2 is greater than a median diameter of the first positive electrode active material particles 1. The median diameter of the first positive electrode active material particles 1 is, for example, greater than 1 μm and less than 20 μm. The median diameter of the second positive electrode active material particles is, for example, greater than 1 μm and less than 20 μm.

A film including an ion-conductive material may be present in all or a part of an interface between each of the first positive electrode active material particles 1 and the solid-state electrolyte SE and in all or a part of an interface between each of the second positive electrode active material particles 2 and the solid-state electrolyte SE. A thickness of the film is, for example, greater than or equal to 1 nm and less than or equal to 100 nm. As used herein, the ion-conductive material includes, for example, a compound represented by LiXY, where X is at least one element selected from the group consisting of B (boron), Al (aluminum), Si (silicon), P (phosphorus), Ti (titanium), Ge (germanium), Zr (zirconium), Nb (niobium), In (indium), Sn (tin), Hf (hafnium), Ta (tantalum), and W (tungsten), and Y is at least one element selected from the group consisting of O (oxygen), S (sulfur), F (fluorine), Cl (chlorine), Br (bromine), and I (iodine). The ion-conductive material included in the film is, for example, LiNbO₃.

### [Solid-State Electrolyte Layer 20 and Solid-State Electrolyte SE]

The solid-state electrolyte layer 20 includes the solid-state electrolyte SE. The solid-state electrolyte SE is present not only in the solid-state electrolyte layer 20, but also in each of the first positive electrode active material region L1 and the second positive electrode active material region L2 in the positive electrode active material layer 12. In addition, a part of the solid-state electrolyte SE is in contact with the positive electrode current collector 11 in the vicinity of an interface between the first positive electrode active material region L1 and the positive electrode current collector 11.

The solid-state electrolyte SE is, for example, a material conductive of an ion such as a lithium ion or a sodium ion. In particular, the solid-state electrolyte forming a battery configuration unit in a solid-state battery forms the solid-state electrolyte layer 20 conductive of, for example, a lithium ion between the positive electrode 10 and the negative electrode 30. Specific examples of the solid-state electrolyte include a lithium-containing phosphoric acid compound having a NASICON structure, an oxide having a perovskite structure, and an oxide having a garnet structure or a garnet-like structure. The lithium-containing phosphoric acid compound having the NASICON structure is, for example, LixMy(PO₄)₃ (where 1≤x≤2, 1≤y≤2, and M is at least one selected from the group consisting of Ti, Ge, Al, Ga, and Zr). Examples of the lithium-containing phosphoric acid compound having the NASICON structure include Li_{1.2}Al_{0.2}Ti_{1.8}(PO₄)₃. Examples of the oxide having the perovskite structure include La_{0.55}Li_{0.35}TiO₃. Examples of the oxide having the garnet structure or the garnet-like structure include Li₇La₃Zr₂O₁₂. Examples of the solid-state electrolyte conductive of a sodium ion include a sodium-containing phosphoric acid compound having a NASICON structure, an oxide having a perovskite structure, and an oxide having a garnet structure or a garnet-like structure. Examples of the sodium-containing phosphoric acid compound having the NASICON structure include NaxMy(PO₄)₃ (where 1≤x≤2, 1≤y≤2, and M is at least one selected from the group consisting of Ti, Ge, Al, Ga, and Zr).

The solid-state electrolyte layer 20 may include a sintering aid. The sintering aid that may be included in the solid-state electrolyte layer 20 may be selected from, for example, materials similar to the sintering aids that may be included in the positive electrode 10 and the negative electrode 30.

### [Negative Electrode 30]

The negative electrode 30 is an electrode layer including at least a negative electrode active material. The negative electrode 30 includes the negative electrode current collector 31 and the negative electrode active material layer 32. The negative electrode current collector 31 is, for example, a metal foil such as a copper foil. Alternatively, the negative electrode current collector 31 may be a sintered body. This is to allow the solid-state battery 100 to be formed by integral firing, or to reduce an internal resistance of the negative electrode current collector. When the negative electrode current collector is the sintered body, the negative electrode current collector may include a conductive additive and a sintering aid.

### [Negative Electrode Active Material]

As with the positive electrode active material included in the positive electrode 10, the negative electrode active material included in the negative electrode 30 contributes to insertion and extraction of an ion in the solid-state battery 100 and also contributes to supplying and receiving of an electron to and from an external circuit. The ion moves between the positive electrode 10 and the negative electrode 30 via the solid-state electrolyte layer 20. In other words, ion conduction occurs between the positive electrode 10 and the negative electrode 30 via the solid-state electrolyte layer 20. The insertion and extraction of the ion into and from the negative electrode active material involve oxidation and reduction of the negative electrode active material. An electron and a hole for such oxidation and reduction reactions are respectively supplied to the positive electrode 10 and the negative electrode 30, which allows charging and discharging to proceed. The negative electrode active material is, for example, a material which a lithium ion, a sodium ion, a proton (H⁺), a potassium ion (K⁺), a magnesium ion (Mg²⁺), an aluminum ion (Al³⁺), a silver ion (Ag⁺), a fluoride ion (F⁻), or a chloride ion (Cl⁻) is insertable into and extractable from. The negative electrode active material included in the negative electrode 30 includes, for example, at least one selected from the group consisting of, for example: an oxide including at least one element selected from the group consisting of Ti, Si, Sn, Cr, Fe, Nb, and Mo; a graphite-lithium compound; a lithium alloy; a lithium-containing phosphoric acid compound having a NASICON structure; a lithium-containing phosphoric acid compound having an olivine structure; and a lithium-containing oxide having a spinel structure. Examples of the lithium alloy include Li—Al. Examples of the lithium-containing phosphoric acid compound having the NASICON structure include Li₃V₂(PO₄)₃ and LiTi₂(PO₄)₃. Examples of the lithium-containing phosphoric acid compound having the olivine structure include Li₃Fe₂(PO₄)₃ and LiCuPO₄. Examples of the lithium-containing oxide having the spinel structure include Li₄Ti₅O₁₂.

The negative electrode active material which a sodium ion is insertable into and extractable from includes, for example, at least one selected from the group consisting of, for example, a sodium-containing phosphoric acid compound having a NASICON structure, a sodium-containing phosphoric acid compound having an olivine structure, and a sodium-containing oxide having a spinel structure.

### [1.2 Method of Manufacturing Solid-State Battery 100]

A description is given next of an example of a method of manufacturing the solid-state battery 100. In manufacturing the solid-state battery 100, used may be a printing method such as a screen printing method, a green sheet method in which a green sheet is used, or a combined method thereof. One manufacturing method is described below as an example; however, the disclosure is not limited to the following manufacturing method. Temporal matters such as the order of descriptions below are merely for description convenience, and the disclosure is not limited thereto.

First, the positive electrode 10 is fabricated. Specifically, the first positive electrode active material particles 1 having a predetermined median diameter is prepared, following which the first positive electrode active material particles 1 are coated with the ion-conductive material such as LiNbO₃ using a rolling flow coating device. Thereafter, the first positive electrode active material particles 1 coated with the ion-conductive material and the solid-state electrolyte SE are kneaded with each other at a predetermined volume ratio of, for example, 6:4, to thereby produce a first positive electrode active material mixture. In a similar manner, the second positive electrode active material particles 2 having a predetermined median diameter is prepared, following which the second positive electrode active material particles 2 are coated with the ion-conductive material such as LiNbO₃ using the rolling flow coating device. Thereafter, the second positive electrode active material particles 2 coated with the ion-conductive material and the solid-state electrolyte SE are kneaded with each other at a predetermined volume ratio of, for example, 6:4, to thereby produce a second positive electrode active material mixture. Thereafter, the positive electrode current collector 11 is prepared, and the first positive electrode active material mixture is applied on a surface of the positive electrode current collector 11 to thereby produce the first positive electrode active material region L1. Further, the second positive electrode active material mixture is applied on the first positive electrode active material region L1 to thereby produce the second positive electrode active material region L2. In addition, a stacked body in which the first positive electrode active material region L1 and the second positive electrode active material region L2 are stacked in order on the positive electrode current collector 11 is pressed using a press machine to thereby form the positive electrode active material layer 12. In such a manner, the positive electrode 10 is obtained.

Thereafter, the negative electrode 30 is fabricated. Specifically, the negative electrode active material particles and the solid-state electrolyte SE are kneaded with each other at a predetermined volume ratio of, for example, 6:4, to thereby produce a negative electrode active material mixture. Thereafter, the negative electrode current collector 31 is prepared, and the negative electrode active material mixture is applied on a surface of the negative electrode current collector 31. Thereafter, the negative electrode active material mixture applied on the negative electrode current collector 31 is pressed using a press machine to thereby form the negative electrode active material layer 32 on the negative electrode current collector 31. In such a manner, the negative electrode 30 is obtained.

Lastly, the positive electrode 10, the solid-state electrolyte layer 20, and the negative electrode 30 are stacked in order into a stacked body, following which the stacked body is compressed using a press machine to thereby fabricate the solid-state battery 100.

### [1.3 Action and Effects of Solid-State Battery]

Examples of important characteristics generally demanded of a solid-state battery include a volumetric energy density, a high-speed charge and discharge characteristic, and durability. Those characteristics are often limited in particular by a positive electrode of the solid-state battery. Examples of a common measure for improving the volumetric energy density include increasing a particle size distribution, and improving a geometric filling density by using a positive electrode active material having a bimodal particle size distribution. Further, in order to improve the high-speed charge and discharge characteristic, a measure of increasing a reactive surface area by using positive electrode active material particles each having a smaller particle size is generally known; however, simply reducing the particle size of each of the positive electrode active material particles causes the filling density of the positive electrode active material particles in a positive electrode active material layer to decrease. Furthermore, for the purposes of suppressing a reaction between the positive electrode active material particles and a solid-state electrolyte and improving the durability of the positive electrode active material particles, it is desired to provide a film including the ion-conductive material on an interface between each of the positive electrode active material particles and the solid-state electrolyte. However, because the film requires a certain degree of thickness, a volume of the film that occupies the positive electrode active material layer with respect to a volume of the positive electrode active material particles becomes relatively large with a reduction in the particle size of each of the positive electrode active material particles. This gives rise to a subsidiary issue that the reduction in the particle size of each of the positive electrode active material particles causes a decrease in an energy density per volume of the active material.

In the solid-state battery 100 of the present embodiment, the positive electrode active material layer 12 includes the first positive electrode active material region L1 and the second positive electrode active material region L2 stacked in order from a side of the positive electrode current collector 11. Here, the volume ratio between the first positive electrode active material particles 1 and the solid-state electrolyte SE in the first positive electrode active material region L1 is within a range from 6:4 to 8:2 both inclusive. In addition, the median diameter of the first positive electrode active material particles 1 is smaller than the median diameter of the second positive electrode active material particles 2. This allows a larger amount of the solid-state electrolyte SE to be present around the first positive electrode active material particles 1. Accordingly, in the solid-state battery 100 including the positive electrode 10, a favorable ion conduction path is formed, and it is thus possible to achieve superior performance such as an improved rate characteristic without an energy density being impaired.

In the solid-state battery 100 of the present embodiment, the film including the ion-conductive material such as LiNbO₃ is present in all or a part of the interface between each of the first positive electrode active material particles 1 and the solid-state electrolyte and in all or a part of the interface between each of the second positive electrode active material particles 2 and the solid-state electrolyte. It is therefore possible to form an even more favorable ion conduction path and to thereby achieve even more superior performance.

Further, in the solid-state battery 100 of the present embodiment, a part of the solid-state electrolyte SE is in contact with the positive electrode current collector 11 in the vicinity of the interface between the first positive electrode active material region L1 and the positive electrode current collector 11. The solid-state battery 100 therefore makes it possible to form an even more favorable ion conduction path and to thereby achieve even more superior performance.

### 2. EXAMPLES

A description is given of Examples of the disclosure.

### Example 1

A solid-state battery (a half cell) for evaluation was fabricated, following which the solid-state battery for evaluation was evaluated for its battery characteristic as described below. The solid-state battery for evaluation included: a positive electrode of the disclosure illustrated in FIG. 1, i.e., an electrode for evaluation; a reference electrode as a counter electrode to the positive electrode; and a solid-state electrolyte layer provided between the positive electrode and the reference electrode. As the reference electrode, an indium-lithium alloy foil was used.

### [Fabrication of Positive Electrode]

First, an Al (aluminum) foil was prepared as a positive electrode current collector. Thereafter, Li(Ni_{0.5}Co_{0.2}Mn_{0.3})O₂ having a median diameter D50(1) of 5.0 μm was prepared as first positive electrode active material particles. The first positive electrode active material particles were each coated with LiNbO₃ as an ion-conductive material to have a target thickness value of 5 nm using a rolling flow coating device (“MP-01” available from Powrex Corporation). Thereafter, the first positive electrode active material particles coated with LiNbO₃, and Li₆PS₅Cl as a solid-state electrolyte were kneaded with each other at a volume ratio of 6:4, to thereby produce a first positive electrode active material mixture. Thereafter, Li(Ni_{0.5}Co_{0.2}Mn_{0.3})O₂ having a median diameter D50(2) of 10.0 μm was prepared as second positive electrode active material particles. The second positive electrode active material particles were each coated with LiNbO₃ as the ion-conductive material to have a target thickness value of 5 nm using the rolling flow coating device (“MP-01” available from Powrex Corporation). Thereafter, the second positive electrode active material particles coated with LiNbO₃, and Li₆PS₅Cl as the solid-state electrolyte were kneaded with each other at a volume ratio of 6:4, to thereby produce a second positive electrode active material mixture. Thereafter, the first positive electrode active material mixture was applied on a surface of the positive electrode current collector to thereby produce a first positive electrode active material region, and the second positive electrode active material mixture was applied on the first positive electrode active material region to thereby produce a second positive electrode active material region. Thereafter, a stacked body in which the first positive electrode active material region and the second positive electrode active material region were stacked in order on the positive electrode current collector was pressed at a pressure of 98 MPa using a press machine to thereby form a positive electrode active material layer. The positive electrode was thus obtained. Note that in Examples, a thickness of the first positive electrode active material region and a thickness of the second positive electrode active material region were each set to 30 μm.

### [Fabrication of Solid-State Battery (Half Cell)]

To the positive electrode obtained as described above, the solid-state electrolyte layer (also referred to as a separator) including the solid-state electrolyte Li₆PS₅Cl was attached, following which pressing at a pressure of 98 MPa and pressing at a pressure of 588 MPa were sequentially performed using a press machine to thereby form a stacked body of the positive electrode and the solid-state electrolyte layer. Further, the indium-lithium alloy foil as a negative electrode was attached to an opposite side of the solid-state electrolyte layer to the positive electrode to thereby obtain the solid-state battery (the half cell).

### [Evaluation of Battery Characteristic]

Evaluation of the fabricated solid-state battery of Example 1 for its battery characteristic revealed the result presented in Table 1. Here, a charge capacity [mAh/g] when the solid-state battery of Example 1 was charged at a rate of 2 C in a room temperature environment was measured. Note that 1 C was a magnitude of a current that caused a theoretical capacity of the battery to be completely charged (or discharged) in one hour in constant current charging and discharging. Further, the solid-state battery of Example 1 was cut in the stacking direction to expose a section along the stacking direction, and an image of the section was acquired using a scanning electron microscopy (SEM). A filling rate of the first positive electrode active material particles and the second positive electrode active material particles in the entire positive electrode active material layer was measured by analyzing the image of the section.

TABLE 1

| | | | | | | Volume | 2 C | Volumetric |
|---|---|---|---|---|---|---|---|---|
| | | | | | Filling | ratio (active | charge | energy |
| | | | D50(2)/ | | rate | material: | capacity | density |
| | D50(1) | D50(2) | D50(1) | Film | [%] | electrolyte) | [mAh/g] | [mAh/cm³] |
| Example 1 | 5.0 | 10.0 | 2.0 | Yes | 90 | 6:4 | 57 | 145 |
| Example 2 | 2.0 | 5.0 | 2.5 | Yes | 85 | 6:4 | 65 | 154 |
| Example 3 | 2.0 | 10.0 | 5.0 | Yes | 88 | 6:4 | 60 | 149 |
| Example 4 | 5.0 | 10.0 | 2.0 | Yes | 89 | 7:3 | 55 | 161 |
| Example 5 | 2.0 | 5.0 | 2.5 | No | 85 | 6:4 | 30 | 73 |
| Comparative | 7.5 | 7.5 | 1.0 | Yes | 90 | 6:4 | 49 | 124 |
| example 1 | | | | | | | | |
| Comparative | 10.0 | 5.0 | 0.5 | Yes | 90 | 6:4 | 42 | 107 |
| example 2 | | | | | | | | |
| Comparative | 3.5 | 3.5 | 1.0 | Yes | 85 | 6:4 | 55 | 130 |
| example 3 | | | | | | | | |
| Comparative | 5.0 | 2.0 | 0.4 | Yes | 85 | 6:4 | 50 | 118 |
| example 4 | | | | | | | | |
| Comparative | 6.0 | 6.0 | 1.0 | Yes | 86 | 6:4 | 53 | 129 |
| example 5 | | | | | | | | |
| Comparative | 2.0 | 2.0 | 1.0 | Yes | 78 | 6:4 | 65 | 136 |
| example 6 | | | | | | | | |
| Comparative | 5.0 | 2.0 | 0.4 | No | 85 | 6:4 | 15 | 37 |
| example 7 | | | | | | | | |
| Comparative | 10.0 | 5.0 | 0.5 | Yes | 89 | 7:3 | 35 | 102 |
| example 8 | | | | | | | | |
| Comparative | 5.0 | 10.0 | 2.0 | Yes | 90 | 5:5 | 33 | 98 |
| example 9 | | | | | | | | |

### Example 2

As indicated in Table 1, a solid-state battery of Example 2 was fabricated in a manner similar to that in Example 1, except that Li(Ni_{0.5}Co_{0.2}Mn_{0.3})O₂ having a median diameter D50(1) of 2.0 μm was used as the first positive electrode active material particles and Li(Ni_{0.5}Co_{0.2}Mn_{0.3})O₂ having a median diameter D50(2) of 5.0 μm was used as the second positive electrode active material particles. Thereafter, the solid-state battery of Example 2 was evaluated for its battery characteristic in a manner similar to that in Example 1. The results of the evaluation are also presented in Table 1.

### Example 3

As indicated in Table 1, a solid-state battery of Example 3 was fabricated in a manner similar to that in Example 1, except that Li(Ni_{0.5}Co_{0.2}Mn_{0.3})O₂ having a median diameter D50(1) of 2.0 μm was used as the first positive electrode active material particles. Thereafter, the solid-state battery of Example 3 was evaluated for its battery characteristic in a manner similar to that in Example 1. The results of the evaluation are also presented in Table 1.

### Example 4

As indicated in Table 1, a solid-state battery of Example 4 was fabricated in a manner similar to that in Example 1, except that the volume ratio between the first positive electrode active material particles and Li₆PS₅Cl as the solid-state electrolyte and the volume ratio between the second positive electrode active material particles and Li₆PS₅Cl as the solid-state electrolyte were each set to 7:3. Thereafter, the solid-state battery of Example 4 was evaluated for its battery characteristic in a manner similar to that in Example 1. The results of the evaluation are also presented in Table 1.

### Example 5

A solid-state battery of Example 5 was fabricated in a manner similar to that in Example 2, except that the first positive electrode active material particles and the second positive electrode active material particles were each not coated with LiNbO₃. Thereafter, the solid-state battery of Example 5 was evaluated for its battery characteristic in a manner similar to that in Example 1. The results of the evaluation are also presented in Table 1.

### Comparative Example 1

As indicated in Table 1, a solid-state battery of Comparative example 1 was fabricated in a manner similar to that in Example 1, except that Li(Ni_{0.5}Co_{0.2}Mn_{0.3})O₂ having a median diameter D50(1) of 7.5 μm was used as the first positive electrode active material particles and Li(Ni_{0.5}Co_{0.2}Mn_{0.3})O₂ having a median diameter D50(2) of 7.5 μm was used as the second positive electrode active material particles. Thereafter, the solid-state battery of Comparative example 1 was evaluated for its battery characteristic in a manner similar to that in Example 1. The results of the evaluation are also presented in Table 1.

### Comparative Example 2

As indicated in Table 1, a solid-state battery of Comparative example 2 was fabricated in a manner similar to that in Example 1, except that Li(Ni_{0.5}Co_{0.2}Mn_{0.3})O₂ having a median diameter D50(1) of 10.0 μm was used as the first positive electrode active material particles and Li(Ni_{0.5}Co_{0.2}Mn_{0.3})O₂ having a median diameter D50(2) of 5.0 μm was used as the second positive electrode active material particles. Thereafter, the solid-state battery of Comparative example 2 was evaluated for its battery characteristic in a manner similar to that in Example 1. The results of the evaluation are also presented in Table 1.

### Comparative Example 3

As indicated in Table 1, a solid-state battery of Comparative example 3 was fabricated in a manner similar to that in Example 1, except that Li(Ni_{0.5}Co_{0.2}Mn_{0.3})O₂ having a median diameter D50(1) of 3.5 μm was used as the first positive electrode active material particles and Li(Ni_{0.5}Co_{0.2}Mn_{0.3})O₂ having a median diameter D50(2) of 3.5 μm was used as the second positive electrode active material particles. Thereafter, the solid-state battery of Comparative example 3 was evaluated for its battery characteristic in a manner similar to that in Example 1. The results of the evaluation are also presented in Table 1.

### Comparative Example 4

As indicated in Table 1, a solid-state battery of Comparative example 4 was fabricated in a manner similar to that in Example 1, except that Li(Ni_{0.5}Co_{0.2}Mn_{0.3})O₂ having a median diameter D50(1) of 2.0 μm was used as the second positive electrode active material particles. Thereafter, the solid-state battery of Comparative example 4 was evaluated for its battery characteristic in a manner similar to that in Example 1. The results of the evaluation are also presented in Table 1.

### Comparative Example 5

As indicated in Table 1, a solid-state battery of Comparative example 5 was fabricated in a manner similar to that in Example 1, except that Li(Ni_{0.5}Co_{0.2}Mn_{0.3})O₂ having a median diameter D50(1) of 6.0 μm was used as the first positive electrode active material particles and Li(Ni_{0.5}Co_{0.2}Mn_{0.3})O₂ having a median diameter D50(2) of 6.0 μm was used as the second positive electrode active material particles. Thereafter, the solid-state battery of Comparative example 5 was evaluated for its battery characteristic in a manner similar to that in Example 1. The results of the evaluation are also presented in Table 1.

### Comparative Example 6

As indicated in Table 1, a solid-state battery of Comparative example 7 was fabricated in a manner similar to that in Example 1, except that Li(Ni_{0.5}Co_{0.2}Mn_{0.3})O₂ having a median diameter D50(1) of 2.0 μm was used as the first positive electrode active material particles and Li(Ni_{0.5}Co_{0.2}Mn_{0.3})O₂ having a median diameter D50(2) of 2.0 μm was used as the second positive electrode active material particles. Thereafter, the solid-state battery of Comparative example 7 was evaluated for its battery characteristic in a manner similar to that in Example 1. The results of the evaluation are also presented in Table 1.

### Comparative Example 7

A solid-state battery of Comparative example 8 was fabricated in a manner similar to that in Comparative example 4, except that the first positive electrode active material particles and the second positive electrode active material particles were each not coated with LiNbO₃. Thereafter, the solid-state battery of Comparative example 8 was evaluated for its battery characteristic in a manner similar to that in Example 1. The results of the evaluation are also presented in Table 1.

### Comparative Example 8

As indicated in Table 1, a solid-state battery of Comparative example 9 was fabricated in a manner similar to that in Comparative example 2, except that the volume ratio between the first positive electrode active material particles and Li₆PS₅Cl as the solid-state electrolyte and the volume ratio between the second positive electrode active material particles and Li₆PS₅Cl as the solid-state electrolyte were each set to 7:3. Thereafter, the solid-state battery of Comparative example 9 was evaluated for its battery characteristic in a manner similar to that in Example 1. The results of the evaluation are also presented in Table 1.

### Comparative Example 9

As indicated in Table 1, a solid-state battery of Comparative example 10 was fabricated in a manner similar to that in Example 1, except that the volume ratio between the first positive electrode active material particles and Li₆PS₅Cl as the solid-state electrolyte and the volume ratio between the second positive electrode active material particles and Li₆PS₅Cl as the solid-state electrolyte were each set to 5:5. Thereafter, the solid-state battery of Comparative example 10 was evaluated for its battery characteristic in a manner similar to that in Example 1. The results of the evaluation are also presented in Table 1.

### DISCUSSION

As indicated in Table 1, in Examples 1 to 4, both high charge capacity and high volumetric energy density were achieved as compared with Comparative examples 1 to 9. One reason for this is considered to be that, in Examples 1 to 4, the volume ratio between the first positive electrode active material particles and the solid-state electrolyte was 6:4 or 7:3, and the median diameter D50(2) of the second positive electrode active material particles was larger than the median diameter D50(1) of the first positive electrode active material particles, which made it possible to form a favorable ion conduction path in the positive electrode active material layer and to thereby improve ion conductivity in the positive electrode.

Further, Example 5 and Comparative example 7 were different from, for example, Examples 1 to 4 in that the first positive electrode active material particles and the second positive electrode active material particles were each not coated with LiNbO₃. Thus, neither Example 5 nor Comparative example 7 had a film formed on each of the first positive electrode active material particles and the second positive electrode active material particles; however, comparison between Example 5 and Comparative example 7 exhibit clear differences in both the charge capacity and the volumetric energy density. That is, both the charge capacity and the volumetric energy density in Example 5 had respective values that were higher than those in Comparative example 7. One reason for this is considered to be that, in Example 5, the volume ratio between the first positive electrode active material particles and the solid-state electrolyte was 6:4 or 7:3, and the median diameter D50(2) of the second positive electrode active material particles was larger than the median diameter D50(1) of the first positive electrode active material particles, which made it possible to form a favorable ion conduction path in the positive electrode active material layer and to improve ion conductivity in the positive electrode.

Although the disclosure has been described above with reference to some embodiments, modifications, and Examples, the configuration of the disclosure is not limited to those described above, and is therefore modifiable in a variety of ways.

Specifically, for example, in the above embodiment, a case where the positive electrode active material layer 12 has a two-layer structure including the first positive electrode active material region L1 and the second positive electrode active material region L2; however, the solid-state battery of the disclosure is not limited thereto. The positive electrode active material layer may have, for example, a multi-layer structure including three or more layers of the positive electrode active material particles whose median diameters vary from layer to layer. In such a case, it is preferable that the median diameter of the positive electrode active material particles in one positive electrode active material region positioned closest to the positive electrode current collector be smaller than the median diameters of the positive electrode active material particles in other positive electrode active material regions.

Further, the effects described herein are mere examples, and effects of the disclosure are not limited to those described herein. Accordingly, the disclosure may achieve any other effect.

In addition, the disclosure may encompass the following embodiments.
<1> A positive electrode including: a positive electrode current collector; and a positive electrode active material layer on the positive electrode current collector, in which the positive electrode active material layer includes: a first positive electrode active material region on the positive electrode current collector, and includes first positive electrode active material particles to each of which a solid-state electrolyte is adhered, and a second positive electrode active material region on a side of the first positive electrode active material region opposite to the positive electrode current collector, and includes second positive electrode active material particles to each of which the solid-state electrolyte is adhered, a first volume ratio between the first positive electrode active material particles and the solid-state electrolyte in the first positive electrode active material region is within a range from 6:4 to 8:2, both inclusive, and a median diameter of the second positive electrode active material particles is greater than a median diameter of the first positive electrode active material particles.
<2> The positive electrode according to <1>, in which a second volume ratio between the second positive electrode active material particles and the solid-state electrolyte in the second positive electrode active material region is within a range from 6:4 to 8:2, both inclusive.
<3> The positive electrode according to <1> or <2>, further comprising a film including an ion-conductive material in all or a part of an interface between each of the first positive electrode active material particles and the solid-state electrolyte and in all or a part of an interface between each of the second positive electrode active material particles and the solid-state electrolyte.
<4> The positive electrode according to <3>, in which the ion-conductive material is a compound represented by LiXY, where X is at least one element selected from boron, aluminum, silicon, phosphorus, titanium, germanium, zirconium, niobium, indium, tin, hafnium, tantalum, and tungsten, and Y is at least one element selected from oxygen, sulfur, fluorine, chlorine, bromine, and iodine.
<5> The positive electrode according to <3> or <4>, in which the ion-conductive material includes LiNbO₃.
<6> The positive electrode according to any one of <1> to <5>, in which a part of the solid-state electrolyte is in contact with the positive electrode current collector.
<7> A solid-state battery including, in order: the positive electrode according to any one of <1> to <6>; a solid-state electrolyte layer; and a negative electrode.

1. A positive electrode comprising:
a positive electrode current collector; and
a positive electrode active material layer on the positive electrode current collector, wherein the positive electrode active material layer includes:
a first positive electrode active material region on the positive electrode current collector, and includes first positive electrode active material particles to each of which a solid-state electrolyte is adhered, and
a second positive electrode active material region on a side of the first positive electrode active material region opposite to the positive electrode current collector, and includes second positive electrode active material particles to each of which the solid-state electrolyte is adhered,
a first volume ratio between the first positive electrode active material particles and the solid-state electrolyte in the first positive electrode active material region is within a range from 6:4 to 8:2, both inclusive, and
a median diameter of the second positive electrode active material particles is greater than a median diameter of the first positive electrode active material particles.

2. The positive electrode according to claim 1, wherein a second volume ratio between the second positive electrode active material particles and the solid-state electrolyte in the second positive electrode active material region is within a range from 6:4 to 8:2, both inclusive.

3. The positive electrode according to claim 1, further comprising a film including an ion-conductive material in all or a part of an interface between each of the first positive electrode active material particles and the solid-state electrolyte and in all or a part of an interface between each of the second positive electrode active material particles and the solid-state electrolyte.

4. The positive electrode according to claim 3, wherein the ion-conductive material is a compound represented by LiXY, where X is at least one element selected from boron, aluminum, silicon, phosphorus, titanium, germanium, zirconium, niobium, indium, tin, hafnium, tantalum, and tungsten, and Y is at least one element selected from oxygen, sulfur, fluorine, chlorine, bromine, and iodine.

5. The positive electrode according to claim 3, wherein the ion-conductive material comprises LiNbO₃.

6. The positive electrode according to claim 3, wherein a thickness of the film is greater than or equal to 1 nm and less than or equal to 100 nm.

7. The positive electrode according to claim 1, wherein a part of the solid-state electrolyte is in contact with the positive electrode current collector.

8. The positive electrode according to claim 1, wherein a material of the first positive electrode active material particles is at least one selected from a lithium-containing phosphoric acid compound having a NASICON structure, a lithium-containing phosphoric acid compound having an olivine structure, a lithium-containing layered oxide, and a lithium-containing oxide having a spinel structure.

9. The positive electrode according to claim 8, wherein a material of the second positive electrode active material particles is at least one selected from the lithium-containing phosphoric acid compound having the NASICON structure, the lithium-containing phosphoric acid compound having the olivine structure, the lithium-containing layered oxide, and the lithium-containing oxide having the spinel structure.

10. The positive electrode according to claim 1, wherein a material of the second positive electrode active material particles is at least one selected from a lithium-containing phosphoric acid compound having a NASICON structure, a lithium-containing phosphoric acid compound having an olivine structure, a lithium-containing layered oxide, and a lithium-containing oxide having a spinel structure.

11. The positive electrode according to claim 1, wherein a filling rate of the positive electrode active material layer is greater than or equal to 85%.

12. The positive electrode according to claim 1, wherein the median diameter of the first positive electrode active material particles is greater than 1 μm and less than 20 μm.

13. The positive electrode according to claim 12, wherein the median diameter of the second positive electrode active material particles is greater than 1 μm and less than 20 μm.

14. The positive electrode according to claim 1, wherein the median diameter of the second positive electrode active material particles is greater than 1 μm and less than 20 μm.

15. A solid-state battery comprising, in order:
the positive electrode according to claim 1;
a solid-state electrolyte layer; and
a negative electrode.
